(19) United States
(12) Patent Application Publication
(10) Pub. No.: US 2016/0354841 A1
(43) Pub. Date: Dec. 8, 2016

(54) METHOD OF FABRICATING AN ARTICLE FOR MAGNETIC HEAT EXCHANGER

(71) Applicant: Vacuumschmelze GmbH & Co. KG, Hanau (DE)

(72) Inventors: Hugo Abdiel VIEYRA VILLEGAS, Hanau (DE); Matthias KATTER, Alzenau (DE); Barcza ALEXANDER, Hanau (DE)

(21) Appl. No.: 15/171,765

(22) Filed: Jun. 2, 2016

(30) Foreign Application Priority Data
Jun. 3, 2015 (GB) 1509612.6

(51) Int. Cl. B22F 3/16; B22F 3/20; B22F 3/22; F25B 21/00; H01F 1/01; B22F 3/18; B01J 2/16; B22F 1/00; B33Y 10/00

(52) U.S. Cl. CPC B22F 3/16; B22F 1/0074; B22F 3/20; B22F 3/225; B33Y 10/00; H01F 1/015; B22F 3/22; B22F 3/18; B01J 2/16; F25B 21/00; B22F 2201/20; B22F 2201/013; B22F 2201/10

(57) ABSTRACT

A method of fabricating an article for magnetic heat exchange is provided. The method comprises mixing a binder comprising a poly (alkylene carbonate) and powder comprising a magnetocalorically active phase with a NaZn₁₃-type crystal structure to produce a brown body or powder comprising elements in amounts suitable to produce a magnetocalorically active phase with a NaZn₁₃-type crystal structure, removing the binder from the brown body to produce a green body, and sintering the green body to produce an article for magnetic heat exchange.

This US patent application claims priority to UK patent application no. 1509612.6, filed Jun. 3, 2015, the entire content of which is incorporated herein by reference.

### BACKGROUND

1. Field

The invention relates to methods of fabricating a working component for magnetic heat exchange.

2. Related Art

Practical magnetic heat exchangers, such as that disclosed in U.S. Pat. No. 6,676,772 for example, may include a pumped recirculation system, a heat exchange medium such as a fluid coolant, a chamber packed with particles of a working material which displays the magnetocaloric effect and a means for applying a magnetic field to the chamber. The working material can be said to be magnetocalorically active.

The magnetocaloric effect describes the adiabatic conversion of a magnetically induced entropy change to the evolution or absorption of heat. Therefore, by applying a magnetic field to a magnetocalorically active working material, an entropy change can be induced which results in the evolution or absorption of heat. This effect can be harnessed to provide refrigeration and/or heating.

Magnetic heat exchangers are, in principle, more energy efficient than gas compression/expansion cycle systems. They are also considered environmentally friendly as chemicals such as hydrofluorocarbons (HFC) which are thought to contribute to the depletion of ozone levels are not used.

In practice, a magnetic heat exchanger requires magnetocalorically active material having several different magnetic phase transition temperatures in order to provide cooling over a wider temperature range. In addition to a plurality of magnetic phase transition temperatures, a practical working medium should also have a large entropy change in order to provide efficient refrigeration and/or heating.

A variety of magnetocalorically active phases are known which have magnetic phase transition temperatures in a range suitable for providing domestic and commercial air conditioning and refrigeration. One such magnetocalorically active material, disclosed for example in U.S. Pat. No. 7,063,754, has a NaZn₁₃-type crystal structure and may be represented by the general formula La (Fe_{1-x-y}T_{y}Mₓ)₁₃H_{z}, where M is at least one element of the group consisting of Si and Al, and T may be one or more of transition metal elements such as Co, Ni, Mn and Cr. The magnetic phase transition temperature of this material may be adjusted by adjusting the composition.

Consequently, magnetic heat exchanger systems are being developed in order to practically realize the potential advantages provided by these magnetocalorically active materials. However, further improvements are desirable to enable a more extensive application of magnetic heat exchange technology.

### SUMMARY

A method of fabricating an article for magnetic heat exchange is provided. The method comprises mixing a binder comprising a poly (alkylene carbonate) and powder comprising a magnetocalorically active phase with a NaZn₁₃-type crystal structure or powder comprising elements in amounts suitable to produce a magnetocalorically active phase with a NaZn₁₃-type crystal structure to produce a brown body, removing the binder from the brown body to produce a green body, and sintering the green body to produce an article for magnetic heat exchange.

A powder metallurgical process is used to produce a sintered article for magnetic heat exchange which includes a magnetocalorically active phase with a NaZn₁₃-type crystal structure. La₁₋ₐRₐ (Fe_{1-x-y}T_{y}Mₓ)₁₃H_{z}C_{b} is an example of a magnetocalorically active phase with a NaZn₁₃-type structure, wherein M is Si and, optionally, Al, T is one or more of the elements from the group consisting of Mn, Co, Ni, Ti, V and Cr and R is one or more of the elements from the group consisting of Ce, Nd, Y and Pr, wherein 0≦a≦0.5, 0.05≦x≦0.2, 0.003≦y≦0.2, 0≦z≦3 and 0≦b≦1.5. The method may be used to fabricate articles with a near net shape so that loss of material, for example by singulating a large article into smaller articles, is reduced.

The powder may include the magnetocalorically active phase. The powder may include elements in amounts suitable to produce a magnetocalorically active phase with a NaZn₁₃-type crystal structure. The magnetocalorically active phase may be formed from these elements by subjecting the green body to a heat treatment suitable for producing the magnetocalorically active phase with the NaZn₁₃-type crystal structure from the elements. For example, the magnetocalorically active phase may be formed by reactive sintering the green body.

The use of a binder comprising a poly (alkylene carbonate) enables the production of a finished sintered article with a low carbon and oxygen content, since polyalkylene carbonate binders may be removed without leaving residues or components of a reaction with the elements of the magnetocalorically active phase. Poly (alkylene carbonate) binders are found to be particularly suitable for La₁₋ₐRₐ(Fe_{1-x-y}T_{y}Mₓ)₁₃H_{z}C_{b}.

In an embodiment, the poly (alkylene carbonate) comprises a decomposition temperature of less than 300° C., preferably less than 200° C. This assists in the removal of the binder from the mixture to form the green body. The poly (alkylene carbonate) may comprise one of the group consisting of poly (ethylene carbonate), poly (propylene carbonate), poly (butylene carbonate) and poly (cyclohexene carbonate). If poly (propylene carbonate) is used, it may have a relative molecular mass of 13,000 to 350,000, preferably 90,000 to 350,000.

The binder to powder ratio may be adjusted. In some embodiments, the mixture comprises 0.1 weight percent to 10 weight percent binder, preferably 0.5 weight percent to 4 weight percent binder. A higher binder content may be used to increase the mechanical stability of the brown body.

The binder may be removed by heat treating the brown body at a temperature of less than 400° C. The heat treatment may be carried out in a noble gas atmosphere, a hydrogen-containing atmosphere or under vacuum. The heat treatment may be carried out for 30 min to 20 hours, preferably, 2 hours to 6 hours. The brown body may be heat treated under conditions such that at least 90% by weight of the binder, preferably more than 95 weight percent, is removed.

In some embodiments, the method comprises mixing a solvent with the binder and the powder to form a mixture from which a precursor article is formed. In these embodiments, the solvent may then be removed from the precursor article to form the brown body. The solvent may be removed by drying the precursor article, for example the precursor article may be dried by heat treating the precursor article at a temperature of less than 100° C. under vacuum. The precursor article may be dried by placing the precursor article in a chamber and evacuating the chamber. The solvent may comprise one of the group consisting of 2,2,4-trimethylpentane (isooctane), isopropanol, 3-methoxy-1-butanol, propylacetate, dimethyl carbonate and methylethylketone.

In some embodiments, the binder is Polypropylene carbonate and the solvent is methylethylketone.

In some embodiments, after the formation of the brown body, the method further comprises mechanically forming the brown body. The mechanical forming may deform the brown body and/or increase the density of the brown body. The brown body may be plastically deformable due to the presence of the binder if the binder has a suitable glass transition temperature. For example the brown body may be mechanically deformed at a temperature above the glass transition temperature of the binder.

The brown body may be mechanically formed by injection molding, extrusion, screen printing, foil casting, three-dimensional screen printing, or calendaring, for example.

In some embodiments, the brown body is mechanically formed by extrusion to form a rod, followed by singulation of the rod to form a plurality of brown bodies and rounding the plurality of brown bodies.

The green body may be sintered by heat treating at a temperature between 900° C. and 1200° C., preferably, between 1050° C. and 1150° C. in a noble gas, a hydrogen-containing atmosphere and/or under vacuum.

A sequence of differing atmospheres may be used during sintering. In an embodiment, the sintering is carried out for a total sintering time tₜₒₜ. The green body is initially sintered in vacuum for 0.95tₜₒₜ to 0.75tₜₒₜ and subsequently in a noble gas or hydrogen-containing atmosphere for 0.05tₜₒₜ to 0.25tₜₒₜ.

The magnetocalorically active phase may be La₁₋ₐRₐ (Fe_{1-x-y}T_{y}Mₓ)₁₃H_{z}C_{b}, wherein M is Si and, optionally, Al, T is one or more of the elements from the group consisting of Mn, Co, Ni, Ti, V and Cr and R is one or more of the elements from the group consisting of Ce, Nd, Y and Pr, wherein 0≦a≦0.5, 0.05≦x≦0.2, 0.003≦y≦0.2, 0≦z≦3 and 0≦b≦1.5. In embodiments in which the La₁₋ₐRₐ (Fe_{1-x-y}T_{y}Mₓ)₁₃H_{z}C_{b} phase includes one or more of the elements denoted by R, the content may be 0.005≦a≦0.5. In embodiments in which the La₁₋ₐRₐ (Fe_{1-x-y}T_{y}Mₓ)₁₃H_{z} phase includes hydrogen, the hydrogen content z may be 1.2≦z≦3. If hydrogen is present, it is incorporated interstitially within the NaZn ₁₃ structure.

A magnetocalorically active material is defined herein as a material which undergoes a change in entropy when it is subjected to a magnetic field. The entropy change may be the result of a change from ferromagnetic to paramagnetic behavior, for example. The magnetocalorically active material may exhibit, in only a part of a temperature region, an inflection point at which the sign of the second derivative of magnetization with respect to an applied magnetic field changes from positive to negative.

A magnetocalorically passive material is defined herein as a material which exhibits no significant change in entropy when it is subjected to a magnetic field.

A magnetic phase transition temperature is defined herein as a transition from one magnetic state to another. Some magnetocalorically active phases exhibit a transition from antiferromagnetic to ferromagnetic which is associated with an entropy change. Magnetocalorically active phases such as La₁₋ₐRₐ (Fe_{1-x-y}T_{y}Mₓ)₁₃H_{z}C_{b} exhibit a transition from ferromagnetic to paramagnetic which is associated with an entropy change. For these materials, the magnetic transition temperature can also be called the Curie temperature.

The magnetic phase transition temperature determines the working temperature of the article when used in a magnetic heat exchanger. In order to increase the working temperature range and the operating range of the magnetic heat exchangers one or more articles with two or more differing magnetic transition temperatures may be provided.

The Curie temperature is determined by the composition of the magnetocalorically active La₁₋ₐRₐ (Fe_{1-x-y}T_{y}Mₓ)₁₃H_{z}C_{b} phase which has a NaZn₁₃-type structure. In particular, the Curie temperature may be determined by selecting the elements denoted by T and/or R and/or M in the chemical formula La₁₋ₐRₐ (Fe_{1-x-y}T_{y}Mₓ)₁₃H_{z} and/or Carbon. In a further embodiment, the Curie temperature may also be selected by including hydrogen into the magnetocalorically active La₁₋ₐRₐ (Fe_{1-x-y}T_{y}Mₓ)₁₃H_{z}C_{b} phase.

The two or more portions of the working component may also comprise differing values of a and y. The amount of the elements R and T can be selected so as to determine the Curie temperature of the two more portions. Therefore, the two or more portions comprise differing elements T and/or R and/or values of a and y. For example, substituting the elements Nd, PR and/or Ce for La and/or Mn, Cr, V and Ti for Fe leads to a reduction in the Curie temperature. The Curie temperature can also be increased by substituting Fe with Co and Ni.

Differing values of a and y for a particular element, respectively, may result in differing sintering activities. In this case, the silicon content, x, can be adjusted so that the sintering activity of the portions is more similar so that the sintered portions have a density as required above. In an embodiment, the amount of silicon lies within the range 0.05≦x≦0.2.

In an embodiment, the element T is Mn. Increasing Mn contents, result in decreasing Tc and increasing density in the working component. Therefore, for increasing Mn contents, the silicon 15 content is increased.

### BRIEF DESCRIPTION OF THE DRAWINGS

Embodiments and examples will now be described with reference to the drawings.

FIG. 1 illustrates a schematic diagram of a method of fabricating an article for magnetic heat exchange.

FIG. 2 illustrates graphs of carbon and oxygen uptake for magnetocalorically active powder mixed with differing solvents after aging for different time periods at 70° C.

FIG. 3 illustrates graphs of carbon and oxygen uptake for magnetocalorically active powder mixed with differing solvents after aging for different time periods at a temperature near the evaporation temperature of the solvent.

FIG. 4 illustrates three differing debinding heat treatment profiles.

FIG. 5 illustrates graphs of carbon and oxygen uptake for samples after debinding a PVP binder.

FIG. 6 illustrates graphs of carbon and oxygen uptake for samples after debinding a PVB binder.

FIG. 7 illustrates graphs of carbon and oxygen uptake for samples after debinding a PPC binder.

FIG. 8 illustrates a schematic diagram of apparatus for fluidized bed granulisation.

FIG. 9 illustrates particle size distribution after fluidized bed granulisation of a first composition.

FIG. 10 illustrates particle size distribution after fluidized bed granulisation of a second composition.

FIG. 11 illustrates particle size distribution after fluidized bed granulisation of a third composition.

FIG. 12 illustrates graphs of the adiabatic temperature change of sintered samples fabricated using fluidized bed granulisation.

FIG. 13 illustrates graphs of entropy change of sintered samples fabricated using fluidized bed granulisation.

### DETAILED DESCRIPTION OF EXAMPLE EMBODIMENTS

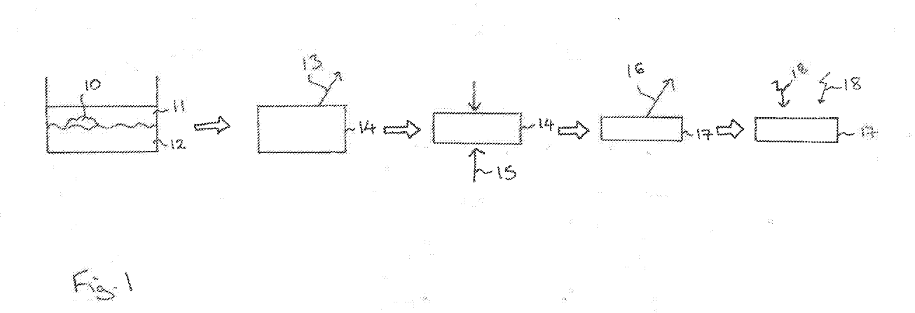

FIG. 1 illustrates a schematic diagram of a method of fabricating an article for magnetic heat exchange, in particular, an article which may be used as, or as part of, a working component of a magnetic heat exchanger.

A binder 10 and a solvent 11 may be mixed with a powder 12 comprising a magnetocalorically active phase with a NaZn₁₃-type crystal structure. In some embodiments, the powder may comprise a composition suitable to form a magnetocalorically active phase after reactive sintering. The binder 10 may comprise a poly (alkylene carbonate), for example poly (ethylene carbonate), polypropylene carbonate, polybutylene carbonate or polycyclohexene carbonate. The solvent 11 may comprise 2,2,4-trimethylpentane, isopropanol, 3 methoxy-1-butanol, propylacetate, dimethyl carbonate or methylethylketone. In one embodiment, the binder 10 is Polypropylene carbonate and the solvent 11 is methylethylketone. The magnetocalorically active phase may be La₁₋ₐRₐ (Fe_{1-x-y}T_{y}Mₓ)₁₃H_{z}C_{b}, wherein M is Si and, optionally, Al, T is one or more of the elements from the group consisting of Mn, Co, Ni, Ti, V and Cr and R is one or more of the elements from the group consisting of Ce, Nd, Y and Pr, wherein 0≦a≦0.5, 0.05≦x≦0.2, 0.003≦y≦0.2, 0≦z≦3 and 0≦b≦1.5.

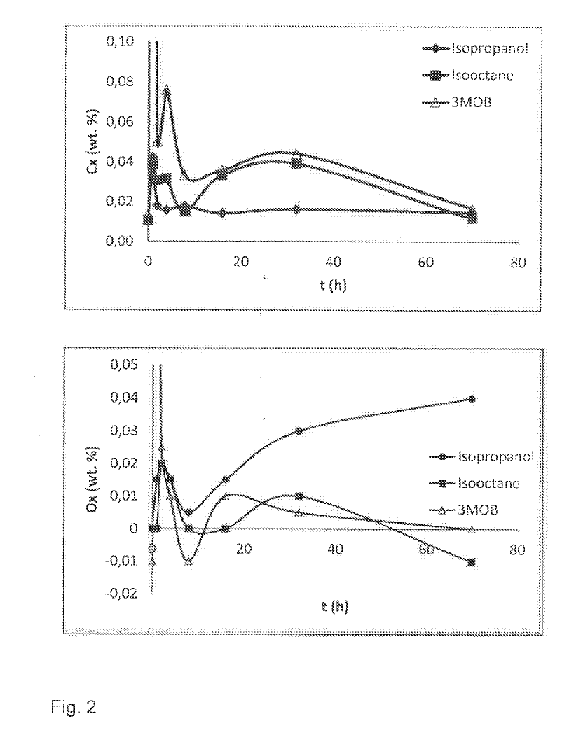

These compositions of the binder 10 and solvent 11 are found to be suitable for the La₁₋ₐRₐ (Fe_{1-x-y}T_{y}Mₓ)₁₃H_{z}C_{b} phase, since they can be removed from powder including this phase leaving an acceptably low residual carbon and oxygen content as is illustrated with the results disclosed in connection with FIGS. 2 to 7.

Around 0.1 weight percent to 10 weight percent, preferably 0.5 weight percent to 4 weight percent of binder may be added to the powder.

The mixture of the binder 10, solvent 11 and powder 12 including a magnetocalorically active phase with a NaZn₁₃-type crystal structure or elements in amounts suitable to produce a magnetocalorically active phase may be further processed by removing some or substantially all of the solvent 11 as is indicated schematically with the arrow 13 to form a brown body 14. The brown body 14 may be mechanically formed, for example to change its shape as is schematically indicated with the arrow 15. The brown body 14 may be mechanically formed by injection moulding, extrusion, casting into a foil, screen printing, three-dimensional screenprinting or calendaring, for example.

In some embodiments, the brown body 14 is formed into granules. The granules may be formed by fluidized bed granulisation. In some embodiments, the brown body 14 may be mechanically formed by extruding the brown body 14 to form a rod, singulating the rod to form a plurality of brown bodies and rounding the least the edges of the plurality of brown bodies.

The binder 10 may then be removed from the brown body 14, as is indicated schematically in FIG. 1 by the arrow 16, to produce a green body 17. The green body 17 may then be sintered, as is schematically indicated in FIG. 1 by arrows 18, to produce an article for magnetic heat exchange. The binder 10 may be removed by heat treating the brown body 14 at a temperature of less than 400° C. in a noble gas atmosphere, a hydrogen containing atmosphere or under vacuum for a period of around 30 min to 20 hours, preferably 2 hours to 6 hours. Preferably, the conditions are selected such that at least 90% by weight or 95% by weight of the binder 10 is removed.

The green body 17 may be sintered at a temperature between 900° C. and 1200° C. in a noble gas atmosphere, a hydrogen containing atmosphere or under vacuum or a combination of these.

In a first group of experiments, three solvents, isopropanol, 3 Methoxy-1-butanol (3MOB) and 2, 2, 4, trimethylpentane (isooctane) are investigated to assess their suitability for use as a solvent with a powder including the La₁₋ₐRₐ(Fe_{1-x-y}T_{y}Mₓ)₁₃H_{z} phase. The chemical formula, evaporation temperature (TEvap) and vapor pressure at 20° C. of the solvents are summarized in table 1.

TABLE 1

| | | | Vapor |
|---|---|---|---|
| | | | pressure |
| | | | at 20° C. |
| | Formula | T_{Evap} (° C.) | (mbar) |
| Isopropanol | C₃H₈O | 82 | 43 |
| 3MOB | C₅H₁₂O₂ | 161 | 1.2 |
| Isooctane | C₈H₁₈ | 99 | 52 |

For the following experiments, 10 g of powder and 7 g of solvent were mixed. The powder was completely covered by the solvent using these proportions.

In a first set of experiments, the mixtures of powder and solvent were aged at 70° C. for time periods in the range of 1 to 70 hours. The control sample was mixed with the solvent at room temperature and, without ageing, directly dried.

FIG. 2 illustrates a graph of the carbon and oxygen uptake for the samples aged at 70° C. as a function of time. Of the three solvents, isopropanol was found to result in the lowest increase in the carbon uptake. Apart from the sample aged for two hours, the carbon uptake remains substantially constant with a value of around 0.016%. The carbon content of the La₁₋ₐRₐ (Fe_{1-x-y}T_{y}Mₓ)₁₃H_{z} phase in 2,2,4,trimethylpentane was found to increase by up to around 0.04 wt % and in 3 Methoxy-1-butanol by up to 0.05 wt %.

However, the effect of the solvents on the oxygen content is observed to differ. Isopropanol is found to cause the greatest increase in the oxygen content of the phase. In contrast, the oxygen content of the powder mixed with 3 Methoxy-1-butanol and 2,2,4, trimethylpentane was found to be lower.

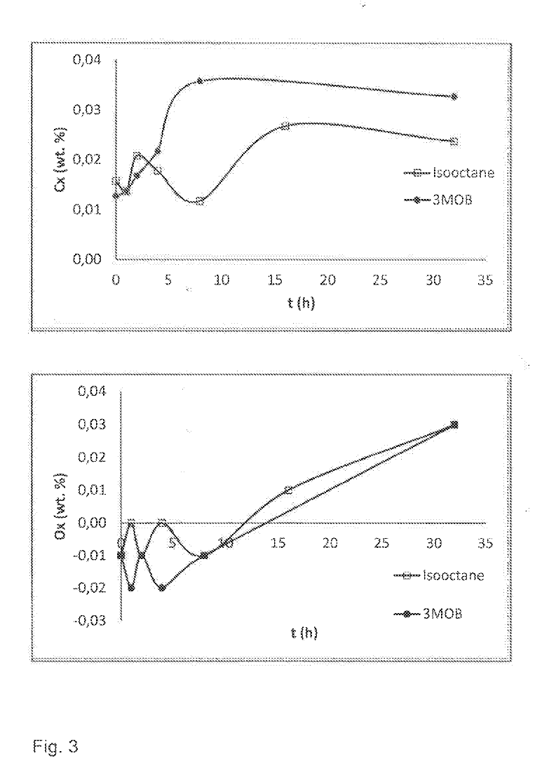

In a second group of experiments, aging was carried out at a temperature close to the evaporation temperature of the solvent. Graphs of the carbon uptake and oxygen uptake of the powder after ageing for time periods of up to 32 hours are illustrated in FIG. 3. For 2, 2, 4, trimethylpentane aged at 90° C., the maximum increase of 0.027 wt % carbon is measured after ageing 16 hours. For 3 Methoxy-1-butanol aged at 140° C., a 25 maximum carbon uptake of 0.033% was found after an ageing period of 8 hours. The increase in oxygen content for aging times of up to 16 hours is negligible for both 2, 2, 4, trimethylpentane and 3 Methoxy-1-butanol. The increased oxygen content seen for samples aged at 32 hours may be caused by external effects.

In a third group of experiments, the suitability of different binders for La₁₋ₐRₐ (Fe_{1-x-y}T_{y}Mₓ)₁₃H_{z}C_{b} is investigated. The binders polyvinylpyrrolidone (PVP), polyvinylbutyral (PVB) and polypropylene carbonate (PPC) are investigated. Samples are made using 0.1, 0.5, 1 and 2 weight percent binder (related to the powder), around 40 g of powder and 20 g of solvent. For PVP and PVB, isopropanol is used as a solvent and for PPC, methylethylketone (MEK) is used as the solvent. The mixtures were in each case mixed for 30 minutes in the turbula mixer and dried at 70° C. for 14 hours under vacuum.

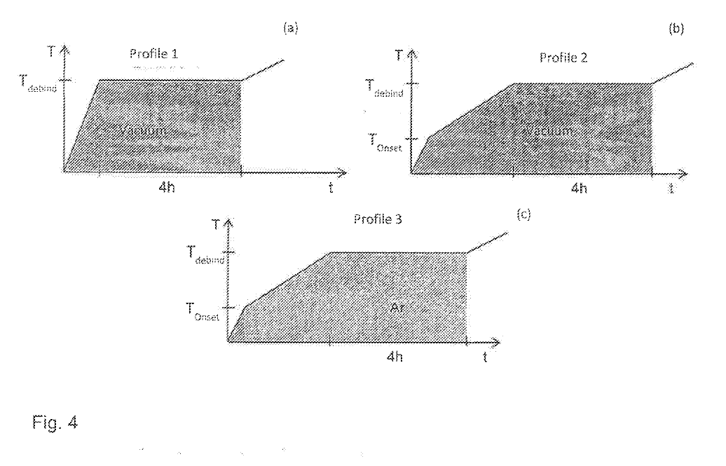

Three types of heat treatment are investigated for removing the binder or debinding. These are illustrated in FIG. 4. In heat treatment 1, the debinding was carried out under vacuum using a constant heating rate to the debinding temperature T_{debind} which was held for four hours. The heating rate is variable between 2° C. per minute and 4° C. per minute. For the second debinding heat treatment, slower heating rates were used. In a first step, sample was heated at around 3° C. per minute to a first temperature Tₒₙₛₑₜ, then the heating rate was slowed to around 0.5 to 1° C. per minute from Tₒₙₛₑₜ to the debinding temperature T_{debind} which was held for 4 hours. The second debinding treatment was also carried out in vacuum.

The third debinding heat treatment uses the same heat treatment profile as the second debinding treatment. However, after reaching the temperature Tₒₙₛₑₜ, the vacuum is replaced by 1300 mbar argon.

After the debinding treatment, the samples are sintered by heating from the debinding temperature to the sinter temperature in 7 hours under vacuum, held at the sintering temperature for 3 hours, the atmosphere changed to argon and the sample held at the sintering temperature for further 1 hour in argon. A further homogenisation heat treatment at 1050° C. for 4 hours in argon is used and the samples cooled quickly to room temperature using compressed air.

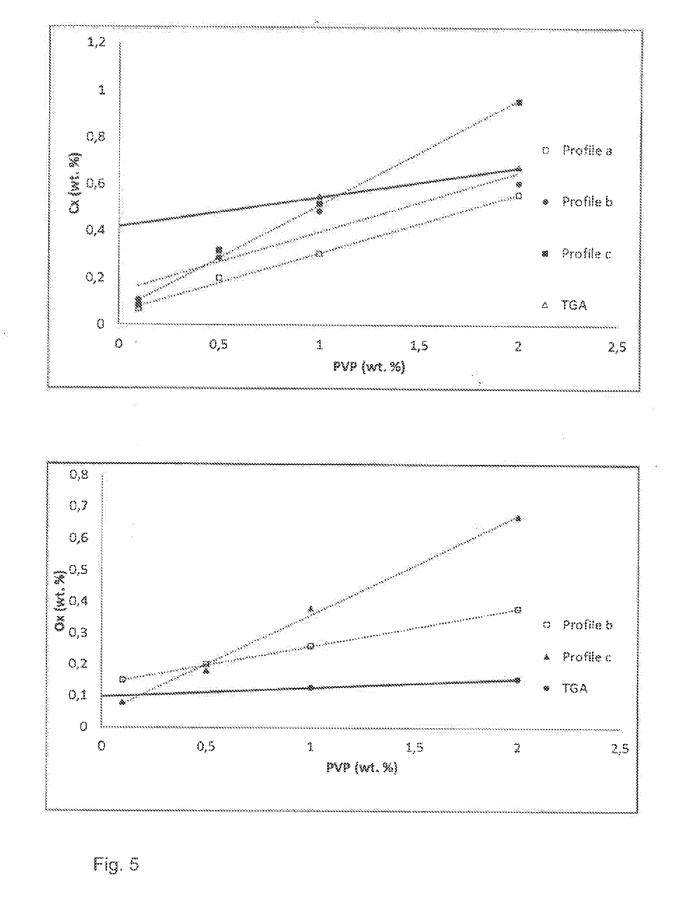

FIG. 5 illustrates the carbon uptake and oxygen uptake measured for samples mixed with PVP after the three debinding heat treatments. Values obtained using thermogravimetric analysis (TGA) in nitrogen are included as a comparison. The debinding temperature T_{debind} is 460° C. and Tₒₙₛₑₜ is 320° C. The debinding treatments carried out entirely under vacuum, that is debinding heat treatments 1 and 2, result in a lower level of increase in carbon than under nitrogen, as is indicated by TGA comparison values illustrated in FIG. 5. The debinding treatment 1 results in the lowest increase in the carbon contents. However, the debinding treatments carried out entirely under vacuum, that is debinding heat treatments 1 and 2, result in a higher level of increase in oxygen than under nitrogen, as is indicated by TGA comparison values illustrated in FIG. 5.

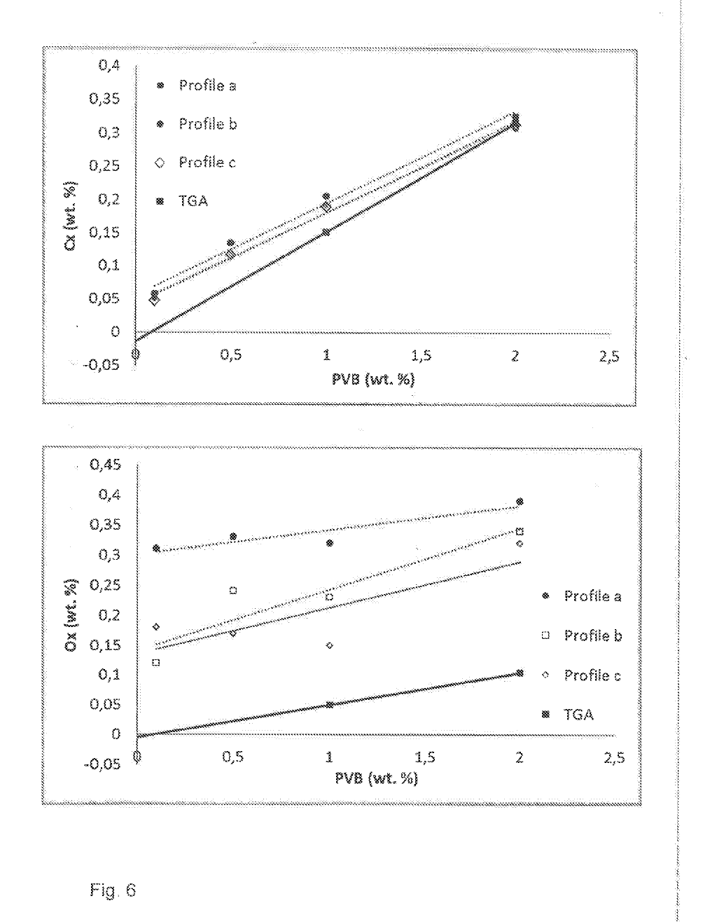

FIG. 6 illustrates the carbon and oxygen uptake measured from samples mixed with PVB after use of each of the three debinding treatments. The debinding temperature T_{debind} is 400° C. and Tₒₙₛₑₜ is 200° C. The use of a PVB binder results in an increase in the carbon content of around 0.3 weight percent and in the oxygen content of around 0.3 weight percent for a binder amount of 2 weight percent. The uptake of carbon and oxygen for PVB is lower compared to PVP. However, about 30% of the binder remains in the final sintered product which may affect the magnetocaloric properties of the material.

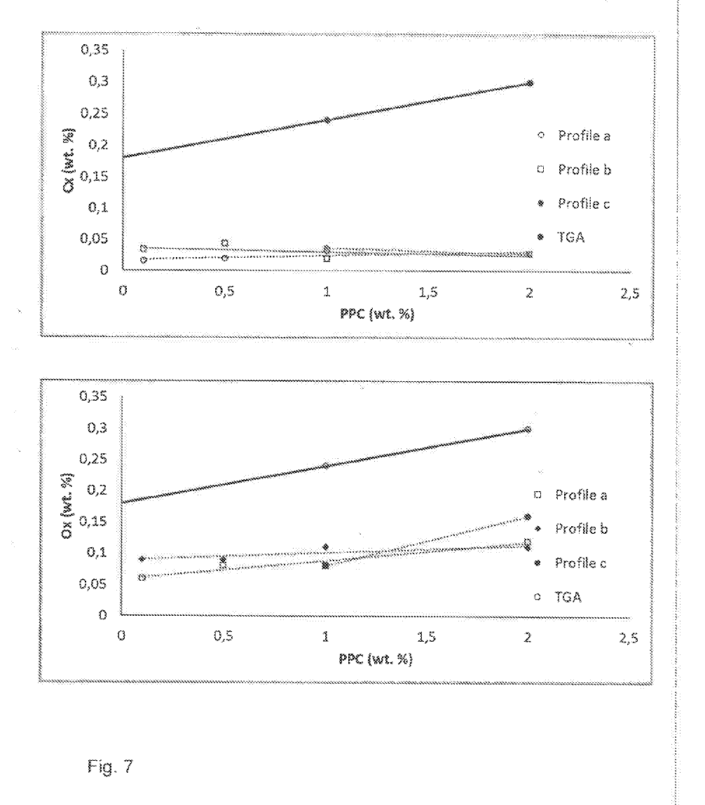

FIG. 7 illustrates a graph of the carbon and oxygen uptake as function of weight percent of PPC binder for samples given each of the three debinding heat treatments. The debinding temperature is 300° C. and Tₒₙₛₑₜ is 100° C. The carbon content remaining in the samples after the debinding treatment is much lower than the TGA values for each of the three debinding heat treatments and it is also much lower compared to PVP and PVB. Also the oxygen uptake is lower than the TGA values for each of the three debinding heat treatments and it is also lower compared to PVP and PVB.

The results are also summarized in table 2. In table 2, the carbon and oxygen uptake values (Cₓ, Oₓ) after debinding for LaFeSi mixed with different binders and under various debinding conditions are shown. The mean density of the debinded and sintered samples is also shown.

TABLE 2

| | PVP | PVB | PPC |
|---|---|---|---|
| Density (mean | 5.99 g/cm³ | 6.70 g/cm³ | 6.72 g/cm³ |
| value) | | | |
| Debinding | Vacuum | Vacuum or Argon | Vacuum or |
| atmosphere | | | Argon |
| debinding | Profile 1 | Profile 2/Profile 3 | Profile 1 |
| profile | | | |
| Cₓ | (0.25 * PVP + | (0.135 * PVB + | (0.0106 * PPC + |
| | 0.06) wt. % | 0.045) wt. % | 0.0153) wt. % |
| Oₓ | (0.12 * PVP + | (0.10 * PVB + | (0.0273 * PPC + |
| | 0.138) wt. % | 0.14) wt. % | 0.0599) wt. % |
| Compatibility | Low | Medium | very high |
| with LaFeSi | | | |

In summary, PPC is a particular suitable binder for the La₁₋ₐRₐ (Fe_{1-x-y}T_{y}Mₓ)₁₃H_{z}C_{b} phase since the increase in carbon and oxygen after the debinding treatment is lowest for the three binders investigated.

As discussed above, the mixture of the powder comprising a magnetocalorically active La₁₋ₐRₐ (Fe_{1-x-y}T_{y}Mₓ)₁₃H_{z} phase, the binder and solvent may be mechanically formed before removal of solvent, for example by casting or screen printing, or after removal of some or substantially all of the solvent by methods such as extrusion or calendaring of the brown body. In some embodiments, spherical granulates or granules are useful for use in the working component of a magnetic heat exchanger or for further processing to form a working component comprising sintered granules.

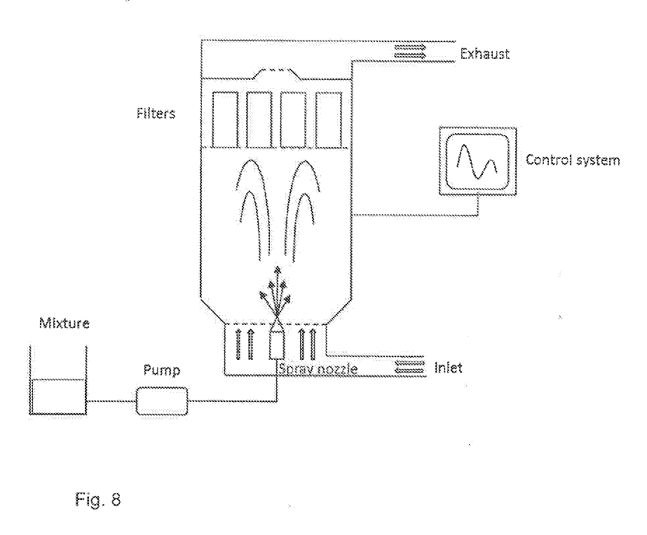

In some embodiments, the spherical or substantially spherical granules may be made using fluidized bed granualisation. FIG. 8 illustrate apparatus for fluidized bed granualisation.

In the fluidized bed granulisation method, powder including the magnetocalorically active phase or precursors thereof or or elements in amounts suitable to produce a magnetocalorically active phase is caused to circulate by application of a gas and a fluid, such as a suitable solvent is sprayed into the moving particles to create the granules. A binder may be added to form stable granules. As discussed above, PPC and methylethylketone is a combination of binder and solvent which is suitable for the La₁₋ₐRₐ (Fe_{1-x-y}T_{y}Mₓ)₁₃H_{z}C_{b} phase. The gas temperature, pressure and speed may be adjusted to adjust the size of the granules formed.

The conditions used to fabricate the granules used fluidized bed granulisation are summarized in table 3.

TABLE 3

| Parameter | Value | |
|---|---|---|
| Starting material | 200 g powder (<315 μm) or granules (<400 μm) | |
| Binder | 2 | wt. % PPC |
| Suspension | 60 wt. % LaFeSi, 40 wt. % MEK | |
| Gas flow | 13 | m³/h |
| Temperature | 45° | C. |
| Spraying rate | 29 | g/min |
| Spraying pressure | 1.5 | bar |
| Purging pressure | 2 | bar |

The nominal compositions of the powders in weight percent are summarized in table 4.

TABLE 4

| Charge | SE | Si | La | Co | Mn | C | O | N | Fe |
|---|---|---|---|---|---|---|---|---|---|
| MFP- | 17.86 | 4.13 | 17.85 | 0.09 | 1.84 | 0.015 | 0.31 | 0.025 | 75.73 |
| 1384 | | | | | | | | | |
| MFP- | 17.82 | 4.12 | 17.81 | 0.1 | 1.65 | 0.015 | 0.3 | 0.024 | 75.96 |
| 1385 | | | | | | | | | |
| MFP- | 17.78 | 4.09 | 17.77 | 0.11 | 1.47 | 0.015 | 0.3 | 0.023 | 76.21 |
| 1386 | | | | | | | | | |

For each powder, three runs in the fluidized bed granulisation apparatus were performed.

In run 1, the binder containing material is used as the starting material. In run 2, granules with a diameter of less than 400 μm obtained from run 1 are mixed with fine powder from the filter and used as the starting powder. In run 3, granules with a diameter less than 400 μm obtained from run 2 are mixed with fine powder from the filter and used as starting material.

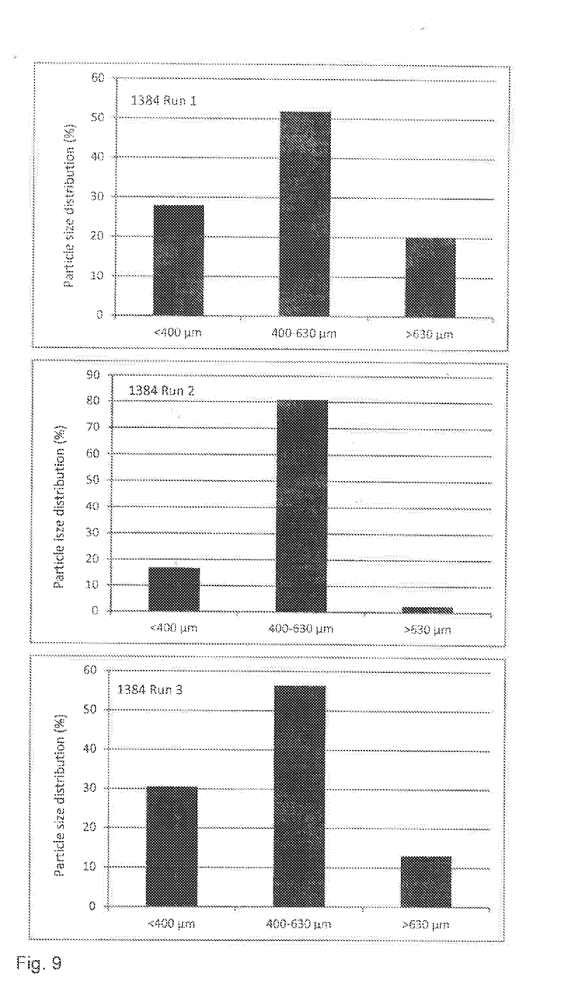

FIG. 9 illustrates the particle size distribution of the granules fabricated using fluidized bed granulisation for powder 1384 using the parameters summarized in table 3.

After the first run, around 51% of granules have a particle size between 400 μm and 630 μm. After the second run, around 80% of the granules produced have the desired particle size of 400 μm to 630 μm. In the third run, the proportion of granules produced having a particle size of 400 μm to 630 μm is less that obtained in the second run. For the third run, 62 g of granules and 138 g of filter powder are used whereas for the second run, 140 g of granules and 86 g of filter powder were used. The yield of granules having a diameter in the desired range of 400 μm to 630 μm appears to be higher, the higher the percentage of granules used in the starting powder.

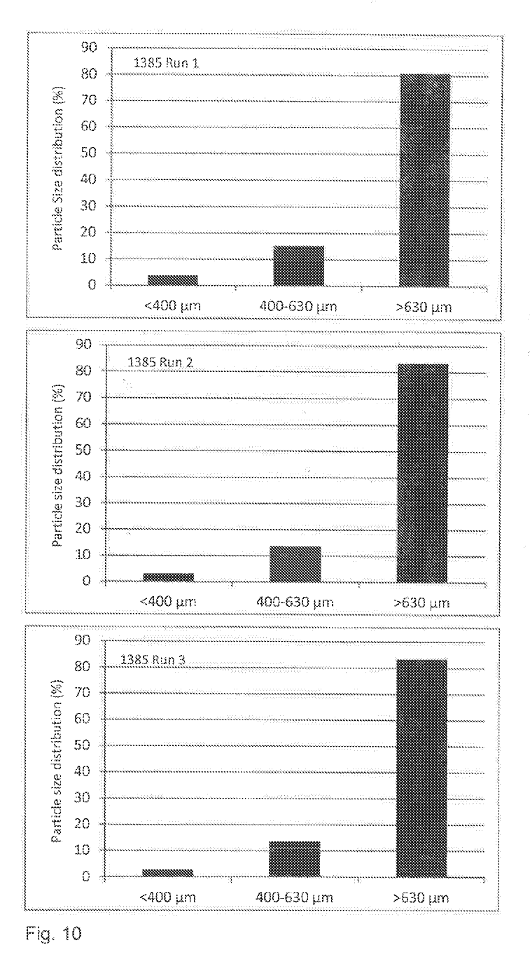

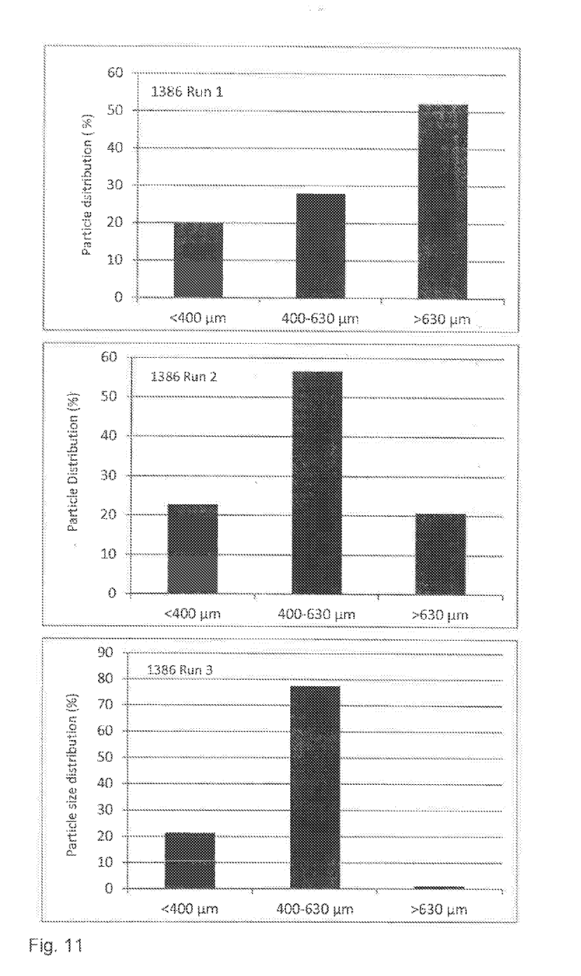

FIG. 10 illustrates the distribution of the particle sizes for composition 1385 after fluidized bed granulisation in run 1, run 2 and run 3. FIG. 11 illustrates the particle size distribution for powder 1386 after fluidized bed in run 1, run 2 and run 3. The results are summarized in table 5.

TABLE 5

| | 1384 | 1384 | 1384 | 1385 | 1385 | 1385 | 1386 | 1386 | 1386 |
|---|---|---|---|---|---|---|---|---|---|
| | Run 1 | Run 2 | Run 3 | Run 1 | Run 2 | Run 3 | Run 1 | Run 2 | Run 3 |
| Starting material | 761 g | 487 g | 405 g | 911 g | 515 g | 679 g | 757 g | 653 g | 468 g |
| Starting material | 230 g | 200 g | 200 g | 80 g | 200 g | 200 g | 200 g | 200 g | 200 g |
| Fraction <400 μm | 113 g | 62 g | 72 g | 17 g | 7 g | 33 g | 95 g | 97 g | 24 g |
| Fraction 400-630 μm | 210 g | 298 g | 133 g | 71 g | 34 g | 23 g | 133 g | 242 g | 90 g |
| Fraction >630 μm | 82 g | 8 g | 31 g | 372 g | 210 g | 243 g | 248 g | 88 g | 1 g |
| Yield | ~41% | ~53% | ~39% | ~46% | ~35% | ~34% | ~49% | ~50% | ~17% |
| Filter powder | 585 g | 318 g | 369 g | 530 g | 462 g | 580 g | 480 g | 425 g | 551 g |

The granules fabricated by fluidized bed granulisation are subjected to a debinding heat treatment and then sintered to form an article comprising magnetocalorically active material for use in magnetic heat exchange. The magnetocaloric properties of the sintered samples are tested to determine if the use of a binder and solvent and the use of fluidized bed granulation affect the magnetocaloric properties.

The granules are packed in iron foil and gettered before the debinding and sintering heat treatments. The debinding temperature is 300° C. and the sinter temperature is 1120° C. The granules are heated under vacuum in 1½ hours to the debinding temperature and held that the debinding temperature 300° C. for 4 hours. Afterwards, the temperature is raised in 7 hours under vacuum to the sintering temperature, held for 3 hours at the sintering temperature under vacuum and additionally for one hour at the sintering temperature in argon. Afterwards the granules are cooled to 1050° C. in 4 hours and held at 1050° C. for 4 hours under argon to homogenize the samples. The samples are then cooled quickly under compressed air to room temperature.

The samples were found to have a carbon uptake of 0.04 weight percent to 0.06 weight percent and an oxygen uptake of 0.15 to 0.3 weight percent. These values correspond substantially to those obtained during the investigation of suitable binders.

The sintered granules are hydrogenated by heating the granules in 2 hours under argon to 500° C. and held for one hour at 500° C. Afterwards, the atmosphere is changed to hydrogen and the samples cooled to room temperature in 8 hours and held under hydrogen for 24 hours. The granules are not found to disintegrate after the hydrogenation treatment.

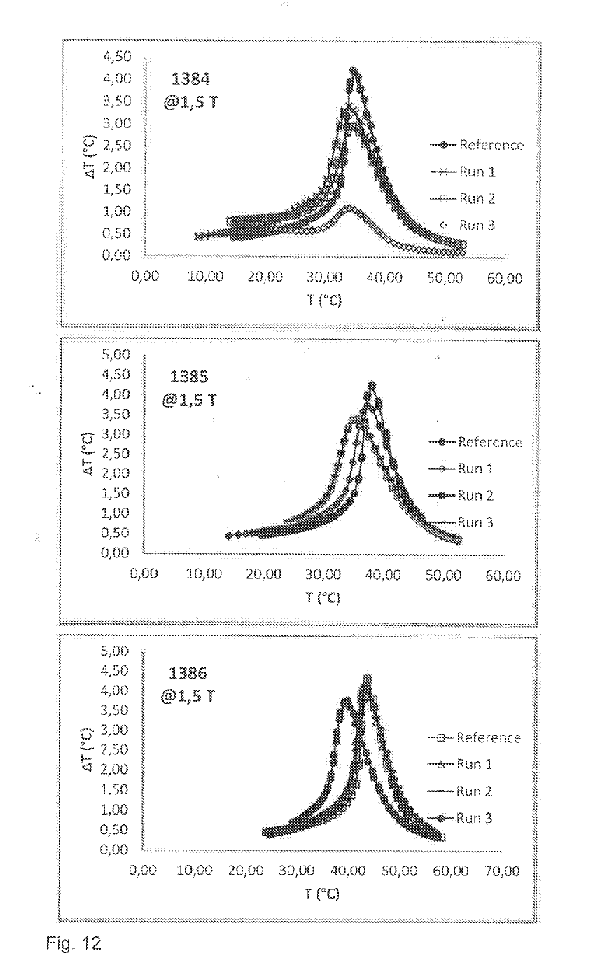

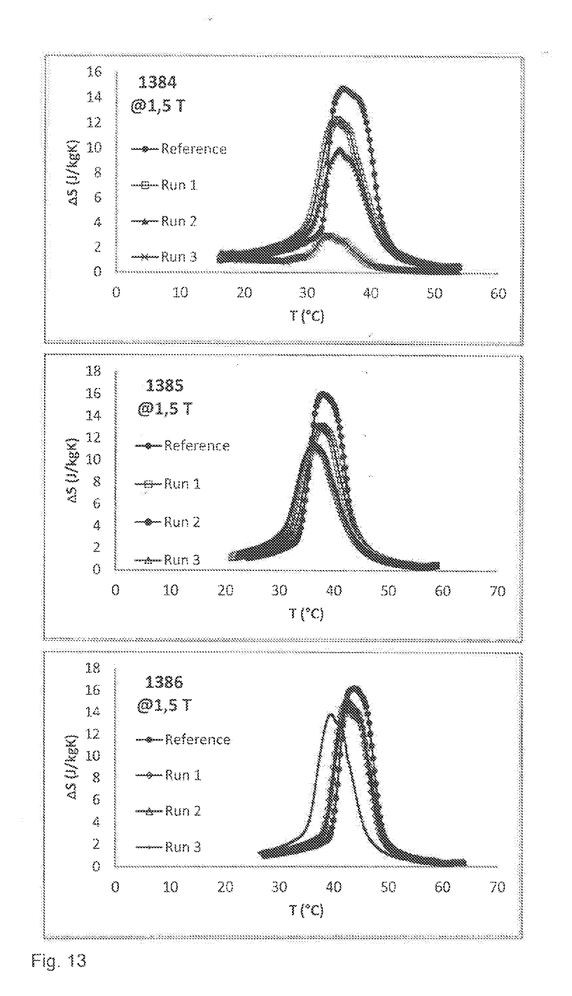

The magnetocaloric properties of the samples are investigated. FIG. 12 illustrates the diagrams of the adiabatic temperature change and FIG. 13 illustrates diagrams of the entropy change for the samples. The results are also summarized in table 6.

TABLE 6

| | 1384 | 1384 | 1384 | 1385 | 1385 | 1385 | 1386 | 1386 | 1386 |
|---|---|---|---|---|---|---|---|---|---|
| @ 1.5 T | Run 1 | Run 2 | Run 3 | Run 1 | Run 2 | Run 3 | Run 1 | Run 2 | Run 3 |
| p (g/cm³) | 6.81 | 6.59 | 6.92 | 6.91 | 6.8 | 6.45 | 6.94 | 6.99 | 7.07 |
| Nominal T_{c} (° C.) | | 30 | | | 35 | | | 40 | |
| T_{Peak} (° C.) | 34.9 | 35.4 | 34.2 | 38.5 | 36.4 | 36.6 | 44.4 | 44.9 | 40.8 |
| ΔT (° C.) | 3.4 | 2.9 | 1.3 | 3.7 | 3.4 | 3.3 | 4.2 | 3.8 | 3.7 |
| ΔT Ref. (° C.) | | 4.32 | | | 4.36 | | | 4.35 | |
| ΔS (J/KgK) | 12.2 | 9.8 | 2.9 | 13 | 11 | 11.3 | 14.9 | 14.3 | 13.7 |
| ΔS Ref. (J/KgK) | | 14.7 | | | 15.9 | | | 16.2 | |
| T_{Peak} (° C.) | 35 | 35.4 | 33.9 | 37.8 | 36.6 | 36.5 | 42.9 | 43.3 | 40 |
| ∝-Fe (wt. %) | 3.7 | 4.7 | 5.4 | 3.8 | 3.3 | 3.8 | 6.2 | 4.7 | 5.3 |

The values of the Curie temperature and entropy change for granules fabricated in the first run are comparable to those of the reference sample fabricated by powder metallurgical techniques without using a binder.

1. A method of fabricating an article for magnetic heat exchange, comprising:
mixing a binder comprising a poly (alkylene carbonate) and powder comprising a magnetocalorically active phase with a NaZn₁₃-type crystal structure or powder comprising elements in amounts suitable to produce a magnetocalorically active phase with a NaZn₁₃-type crystal structure and producing a brown body;
removing the binder from the brown body and producing a green body;
sintering the green body, and producing an article for magnetic heat exchange.

2. The method according to claim 1, wherein the poly (alkylene carbonate) comprises a decomposition temperature of less than 300° C.

3. The method according to claim 1, wherein the polyalklylene carbonate comprises one of the group consisting of poly (ethylene carbonate), poly (propylene carbonate), poly (butylene carbonate) and poly (cyclohexene carbonate).

4. The method according to claim 1, wherein the mixture comprises 0.1 weight percent to 10 weight percent binder.

5. The method according to claim 1, wherein the removing the binder comprises heat treating the brown body at a temperature of less than 400° C.

6. The method according to claim 5, wherein the heat treating the brown body is carried out in at least one of the group consisting of a noble gas atmosphere, a hydrogen-containing atmosphere and vacuum.

7. The method according to claim 1, wherein the removing the binder is carried out for 30 min to 20 hour.

8. The method according to claim 1, wherein at least 90% by weight of the binder, preferably more than 95 weight percent, is removed.

9. The method according to claim 1, further comprising mixing a solvent with the binder and the powder.

10. The method according to claim 9, further comprising removing the solvent from the precursor article and producing the brown body.

11. The method according to claim 10, wherein the removing the solvent comprises drying the precursor article at a temperature of less than 100 C.

12. The method according to claim 9, wherein the solvent comprises one of the group consisting of 2,2,4-Trimethylpentane, isopropanol, 3 Methoxy-1-butanol, propylacetate, dimethyl carbonate and methylethylketone.

13. The method according to claim 9, wherein the binder is Polypropylene carbonate and the solvent is methylethylketone.

14. The method according to claim 1, further comprising mechanically forming the brown body.

15. The method according to claim 14, wherein the mechanically forming the brown body comprises one of the group consisting of injection molding, extrusion, foil casting, screen printing, three-dimensional screen printing and calendaring.

16. The method according to claim 14, wherein the mechanically forming the brown body comprises fluidized bed granulisation.

17. The method according to claim 14, wherein the mechanically forming the brown body comprises extruding the brown body to form a rod, singulating the rod to form a plurality of brown bodies and rounding the plurality of brown bodies.

18. The method according to claim 1, wherein the sintering the green body comprises heat treating at a temperature between 900° C. and 1200° C.

19. The method according to claim 18, wherein the sintering is carried out in a noble gas atmosphere, a hydrogen-containing atmosphere or in vacuum.

20. The method according to claim 18, wherein the sintering is carried out for a total sintering time tₜₒₜ, wherein the green body is sintered in vacuum for 0.95tₜₒₜ to 0.75tₜₒₜ and subsequently in a noble gas or hydrogen-containing atmosphere for 0.05tₜₒₜto 0.256tₜₒₜ.

21. The method according to claim 1, wherein the magnetocalorically active phase is La₁₋ₐRₐ(Fe_{1-x-y}T_{y}Mₓ)₁₃H_{z}C_{b}wherein M is Si and, optionally, Al, T is one or more of the elements from the group consisting of Mn, Co, Ni, Ti, V and Cr and R is one or more of the elements from the group consisting of Ce, Nd, Y and Pr, wherein 0≦a≦0.5, 0.05≦x≦0.2, 0.003≦y≦0.2, 0≦z≦3 and 0≦b≦1.5.

22. The method according to claim 21, wherein 1.2≦z≦3.

23. The method according to claim 21, wherein 0.005≦a≦0.5.
